(19) United States
(12) Patent Application Publication
(10) Pub. No.: US 2017/0139088 A1
(43) Pub. Date: May 18, 2017

(54) LIGHT DIFFUSING AND TRANSMITTING SHEET

(71) Applicant: Nippon Sheet Glass Company, Limited, Tokyo (JP)

(72) Inventors: Koichiro IKI, Mie (JP); Satoru KUSAKA, Tokyo (JP); Takashi MORIMOTO, Hyogo (JP); Takeshi MAEDA, Mie (JP)

(21) Appl. No.: 15/127,710

(22) PCT Filed: Mar. 23, 2015
(86) PCT No.: PCT/JP2015/001645

§ 371 Date: Sep. 20, 2016

(30) Foreign Application Priority Data
Mar. 25, 2014 (JP) 2014-061415

(51) Int. Cl. G02B 5/02

(52) U.S. Cl. CPC G02B 5/0242; G02B 5/0278

(57) ABSTRACT

A light diffusing and transmitting sheet according to the present invention includes a matrix resin and composite particles dispersed in the matrix resin, the composite particles each including a resin component and inorganic fine particles enclosed in the resin component. It is thus possible to provide a light diffusing and transmitting sheet that exhibits good light diffusing properties by containing an inorganic material and that has a reduced possibility of damaging another member which makes contact with the sheet.

### TECHNICAL FIELD

The present invention relates to a light diffusing and transmitting sheet.

### BACKGROUND ART

Techniques for diffusing and transmitting incident light have been conventionally used, for example, in order for a backlight of a liquid crystal display to function as a light source that provides uniform brightness over the entire liquid crystal display. Techniques for diffusing and transmitting light from a light source of a lighting apparatus have been used to obscure the shape of the light source.

A known example of the techniques for diffusing and transmitting incident light is to disperse particles for light diffusion in a sheet on which light from a light source is to be incident.

For example, Patent Literature 1 describes a light diffusing film having a base film containing a light diffusing element in its interior. Usable light diffusing elements mentioned as examples include, as well as certain resins, inorganic materials such as silica, barium sulfate, calcium carbonate, and titanium oxide.

Additionally, Patent Literature 2 describes a light diffusing plate including a transparent base material containing a transparent resin, the transparent base further containing in its interior first light diffusing particles and second light diffusing particles having a refractive index higher than a refractive index of the first light diffusing particles. It is taught that inorganic materials such as titanium dioxide, antimony oxide, barium sulfate, zinc sulfate, zinc oxide, and calcium carbonate are used alone or in combination as the material of the second light diffusing particles. The reflection ability of the second light diffusing particles allows a beam of high-intensity light to diffuse, thus preventing the occurrence of uneven luminance.

### CITATION LIST

### Patent Literature

Patent Literature 1: JP 2007-140477 A

Patent Literature 2: JP 2008-40479 A

### SUMMARY OF INVENTION

### Technical Problem

In some cases, it is desirable, as described above, to disperse an inorganic material in a light diffusing and transmitting sheet in order to improve the light diffusing properties of the light diffusing and transmitting sheet. However, given that inorganic materials generally have high hardness, a light diffusing and transmitting sheet in which an inorganic material is dispersed can damage another member placed on the light diffusing and transmitting sheet. In this case, the damage can cause the occurrence of uneven light diffusion.

Under these circumstances, the present invention aims to provide a light diffusing and transmitting sheet that exhibits good light diffusing properties by containing an inorganic material and that has a reduced possibility of damaging another member which makes contact with the sheet.

### Solution to Problem

The present invention provides a light diffusing and transmitting sheet including:

a matrix resin; and

composite particles dispersed in the matrix resin, the composite particles each including a resin component and inorganic fine particles enclosed in the resin component.

### Advantageous Effects of Invention

According to the present invention, the inorganic fine particles included in each of the composite particles dispersed in the matrix resin are enclosed in the resin component. The hardness of the composite particles is thus lower than the hardness of the inorganic fine particles. This reduces the possibility that another member in contact with the light diffusing and transmitting sheet according to the present invention damages due to the hardness of the inorganic fine particles. Additionally, the light diffusing and transmitting sheet according to the present invention exhibits good light diffusing properties since light incident on the sheet is refracted or reflected at the interfaces between the resin component and the inorganic fine particles.

### BRIEF DESCRIPTION OF DRAWINGS

FIG. 1 is a schematic cross-sectional view of a light diffusing and transmitting sheet according to an embodiment of the present invention.

FIG. 2A is a cross-sectional view schematically showing the structure of a composite particle.

FIG. 2B is a cross-sectional view schematically showing the structure of a composite particle according to another embodiment.

FIG. 2C is a cross-sectional view schematically showing the structure of a composite particle according to still another embodiment.

FIG. 3 is a side view of a device for evaluation of damaging properties.

FIG. 4 is a scanning electron microscope (SEM) photograph of composite particles.

FIG. 5 is a SEM photograph of another type of composite particles.

FIG. 6 is a graph showing the results of evaluation of the haze ratio and luminance for samples.

FIG. 7 is a graph showing light-scattering profiles of samples.

FIG. 8 is a graph showing the relationship between the relative values of luminance measured for samples and the particle diameter of titanium dioxide fine particles.

FIG. 9 is a graph showing the relationship between the relative values of luminance measured for samples and the content of titanium dioxide fine particles.

FIG. 10 is a graph showing half widths at half maximum determined for samples.

FIG. 11 is a graph showing the relationship between the relative values of luminance measured for samples and the content of phthalocyanine blue.

FIG. 12 is a graph showing the relationship between the values of chromaticity y measured for samples and the content of phthalocyanine blue.

### DESCRIPTION OF EMBODIMENTS

Hereinafter, embodiments of the present invention will be described with reference to the drawings. The following description relates to examples of the present invention, and the present invention is not limited by the examples.

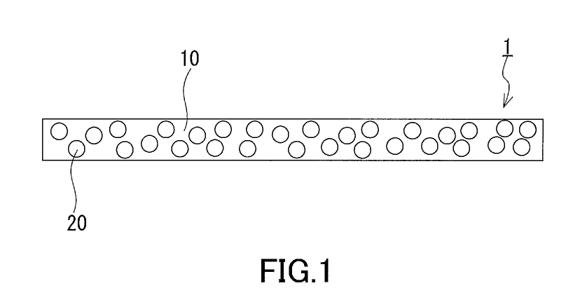

As shown in FIG. 1, a light diffusing and transmitting sheet 1 according to the present invention includes a matrix resin 10 and composite particles 20. The composite particles 20 are dispersed in the matrix resin 10. The matrix resin 10 is desirably, but not limited to, a resin in which the composite particles 20 can be well dispersed and which has transparency to visible light, weather resistance, moisture resistance, and heat resistance. Examples of the matrix resin 10 include a polyester polyol, a linear polyester, an acrylic resin, an amino resin, an epoxy resin, a melamine resin, a silicone resin, a urethane resin, a vinyl acetate resin, a norbornene resin, and a polycarbonate resin. Various thermosetting resins and various ultraviolet-curable resins can also be used. A curing agent such as an isocyanate curing agent or some type of dispersant may be added to these resins as appropriate. The light diffusing and transmitting sheet 1 may further include a substrate such as a polyethylene terephthalate (PET) film, and the matrix resin 10 in which the composite particles 20 are dispersed may be placed in the form of a layer on the substrate.

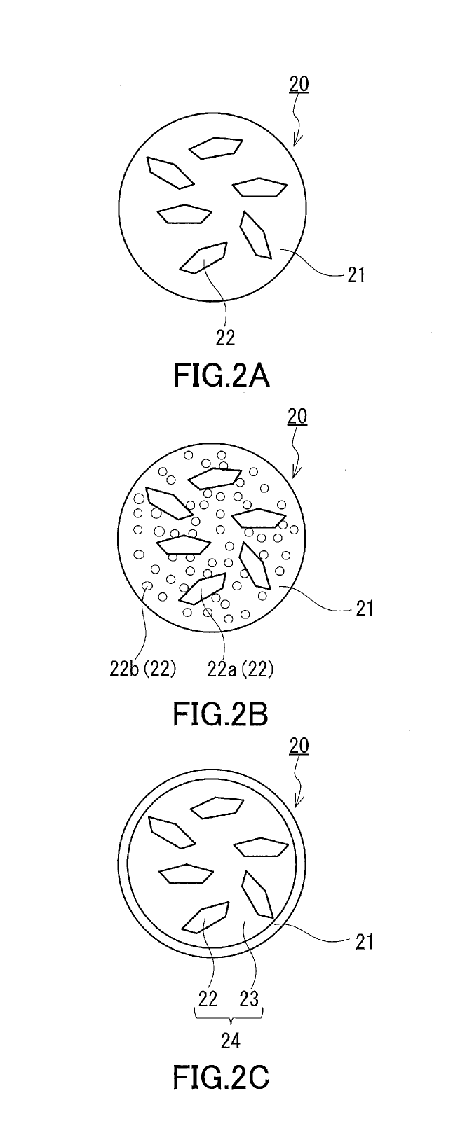

As shown in FIG. 2A, each composite particle 20 includes a resin component 21 and inorganic fine particles 22. The inorganic fine particles 22 are enclosed in the resin component 21. The path of light incident on the light diffusing and transmitting sheet 1 from a light source is influenced by refraction or reflection at the interfaces between the composite particles 20 and the matrix resin 10 or at the interfaces between the resin component 21 and the inorganic fine particles 22. This allows diffusion of the light incident on the light diffusing and transmitting sheet 1. The inorganic fine particles 22 are, for example, fine particles of at least one selected from the group consisting of silica, titanium dioxide, zinc oxide, zirconium oxide, calcium carbonate, barium sulfate, zinc sulfide, aluminum hydroxide, and an extender pigment. In particular, it is advantageous that the inorganic fine particles 22 be, for example, silica fine particles or titanium dioxide fine particles. In such a case, the difference in refractive index between the materials is large, which leads to an increased scattering efficiency of the light diffusing and transmitting sheet 1. The term “fine particles” as used herein refers to particles having a volume-based median diameter D50 of 1 nm to 20 μm as measured by laser diffractometry.

In terms of imparting sufficient light diffusing properties to the light diffusing and transmitting sheet 1 while achieving intended luminance properties of the light diffusing and transmitting sheet 1, the content of the composite particles 20 in the light diffusing and transmitting sheet 1 is, for example, 10 mass % to 90 mass %, desirably 20 mass % to 80 mass %, and more desirably 30 mass % to 70 mass %.

It is desirable that aggregation of primary particles of the composite particles 20 be prevented and that the average particle diameter of the composite particles 20 fall within a predetermined range. In this case, the composite particles 20 can be dispersed uniformly in the matrix resin 10. This results in prevention of spatial variation in the light diffusing properties of the light diffusing and transmitting sheet 1. It is also possible to reduce reflection loss of light caused by entry of light into gaps formed between the primary particles when the primary particles are aggregated together. This leads to an improvement in the luminance properties of the light diffusing and transmitting sheet 1. It is further possible to sufficiently provide interfaces for light refraction in the light diffusing and transmitting sheet 1. This improves the light diffusing properties of the light diffusing and transmitting sheet 1. In view of the above, the average particle diameter of the composite particles 20 is, for example, 1 μm to 20 μm, desirably 1 μm to 15 μm, and more desirably 1 μm to 10 μm. The term “average particle diameter” as used herein refers to a volume median diameter D50 measured by laser diffractometry.

In terms of imparting spatially-uniform light diffusing properties to the light diffusing and transmitting sheet 1, it is desirable for the composite particles 20 to have a shape with an aspect ratio of 0.6 to 1.4. The aspect ratio as defined herein refers to the ratio (da/db) of the major axis da of the composite particle 20 to the minor axis db of the composite particle 20.

It is desirable for the particle diameter of the inorganic fine particles 22 to be controlled so that the inorganic fine particles 22 can be enclosed in the resin component 21 and that interfaces having a size suitable for refraction or reflection of light can be formed between the resin component 21 and the inorganic fine particles 22. In view of this, the average particle diameter of the inorganic fine particles 22 is, for example, 1 nm to 500 nm, desirably 5 nm to 400 nm, and more desirably 10 nm to 350 nm.

It is desirable for the content of the inorganic fine particles 22 and the content of the resin component 21 to be controlled so that the inorganic fine particles 22 can be enclosed in the resin component 21 and that good light diffusing properties and luminance properties can be imparted to the light diffusing and transmitting sheet 1. In view of this, the content of the inorganic fine particles 22 is, for example, 50 mass % to 99 mass %, desirably 60 mass % to 90 mass %, and more desirably 70 mass % to 85 mass %. The content of the resin component 21 is, for example, 1 mass % to 50 mass %, desirably 10 mass % to 40 mass %, and more desirably 15 mass % to 30 mass %.

It is desirable for the resin component 21 to be capable of enclosing the inorganic fine particles 22 and have transparency to visible light. The resin component 21 is, for example, at least one selected from the group consisting of an acrylic resin, a polyurethane resin, and a nylon. In terms of decreasing the hardness of the composite particles 20 to reduce the possibility of damaging a member in contact with the light diffusing and transmitting sheet 1, it is desirable for the resin component 21 to be a polyurethane resin, particularly a polyurethane resin containing a silanol group. In terms of improving the light diffusing properties of the light diffusing and transmitting sheet 1 by allowing significant refraction of light at the interfaces between the resin component 21 and the inorganic fine particles 22, it is desirable that the difference between the refractive index of the resin component 21 and the refractive index of the inorganic fine particles 22 be 0.05 or more.

As shown in FIG. 2B, the composite particle 20 may contain two or more types of inorganic fine particles 22 (two types of particles, first inorganic fine particles 22a and second inorganic fine particles 22b, in FIG. 2B). In this case, for example, the first inorganic fine particles 22a have a relatively high refractive index, while the second inorganic fine particles 22b have a relatively low refractive index. In an example, the first inorganic fine particles 22a have a refractive index which is higher than 2.0 and which is 1 or more higher than the refractive index of the resin component 21. Additionally, it is desirable that the difference between the refractive index of the resin component 21 and the refractive index of the second inorganic fine particles 22b be 0.05 or more. In this case, light is refracted significantly at the interfaces between the resin component 21 and the first inorganic fine particles 22a. Also at the interfaces between the resin component 21 and the second inorganic fine particles 22b there occurs light refraction. This improves the light diffusing properties of the light diffusing and transmitting sheet 1.

The first inorganic fine particles 22a are, for example, titanium dioxide fine particles, while the second inorganic fine particles 22b are, for example, silica fine particles. That is, in an example, the composite particle 20 contains silica fine particles and titanium dioxide fine particles as the inorganic fine particles 22. The refractive index of silica is about 1.45. The refractive index of titanium dioxide is about 2.71 when it is of the rutile type. This difference in refractive index results in an improvement in the light diffusing properties of the light diffusing and transmitting sheet 1. In terms of improving the dispersibility of the silica fine particles in the composite particle 20, the average particle diameter of the silica fine particles is, for example, 1 nm to 100 nm, desirably 3 nm to 50 nm, and more desirably 5 nm to 10 nm. In terms of achieving an appropriate size of the composite particles 20 while reducing the reflection loss of light to improve the luminance properties of the light diffusing and transmitting sheet 1, the average particle diameter of the titanium dioxide fine particles is, for example, 100 nm to 500 nm, desirably 150 nm to 400 nm, and more desirably 200 nm to 350 nm.

In terms of improving the luminance properties of the light diffusing and transmitting sheet 1, it is desirable for the content of the titanium dioxide fine particles in the composite particle 20 to be 10 mass % to 70 mass %.

When the composite particle 20 contains silica fine particles and titanium dioxide fine particles, the composite particle 20 may further contain zinc oxide fine particles, barium sulfate fine particles, or calcium carbonate fine particles as the inorganic fine particles 22. This provides more variations of interfaces between the materials included in the composite particle 20 and leads to diversification of the way of light refraction, thus improving the viewing angle properties of the light diffusing and transmitting sheet 1. In particular, it is desirable for the composite particle 20 to contain zinc oxide fine particles as inorganic fine particles in addition to silica fine particles and titanium dioxide fine particles. The acceptable content of zinc oxide fine particles, barium sulfate fine particles, or calcium carbonate fine particles in the composite particle 20 is, for example, 1 mass % to 20 mass %. In terms of proper enclosure of the inorganic fine particles 22 in the resin component 21, it is desirable for the average particle diameter of the zinc oxide fine particles, barium sulfate fine particles, or calcium carbonate fine particles to be 10 nm to 500 nm.

As shown in FIG. 2C, the composite particle 20 may have a core-shell structure including: a core 24 formed of an inorganic component 23 and inorganic fine particles 22 enclosed in the inorganic component 23; and a resin component 21 coating the core 24. Also in this case, the resin component 21 forming the shell provides some reduction in the hardness of the composite particle 20. However, in terms of sufficiently decreasing the hardness of the composite particle 20 to reduce the possibility of damaging a member in contact with the light diffusing and transmitting sheet 1, it is desirable that the composite particle 20 be such that, as shown in FIG. 2A or FIG. 2B, the resin component 21 is distributed to the central part of the composite particle 20 to serve as a binder in the composite particle 20.

The composite particle 20 may contain another component other than the components described above. For example, the composite particle 20 may further contain a fluorescent dye or a fluorescent brightener. This improves the luminance properties of the light diffusing and transmitting sheet 1. Furthermore, the composite particle 20 may contain a dye or a pigment for adjustment of the chromaticity of light transmitted through the light diffusing and transmitting sheet 1. Examples of the dye include a fluorescent dye and a bluish dye. Examples of the pigment include bluish pigments such as phthalocyanine blue.

An exemplary method for producing the light diffusing and transmitting sheet 1 will now be described. A sol in which the resin component 21 and the inorganic fine particles 22 are dispersed is prepared. Two or more types of inorganic fine particles 22, a fluorescent dye, a fluorescent brightener, a dye, or a pigment may be dispersed in the sol where necessary. The composite particles 20 can be obtained by spray drying using the prepared sol. Aggregation of the primary particles can be inhibited to control the particle diameters of the composite particles 20 within an appropriate range by adjusting the content of solids in the sol and the spraying conditions in the spray drying. In view of this, the content of solids in the sol is, for example, 3 mass % to 30 mass %, desirably 5 mass % to 25 mass %, and more desirably 8 mass % to 22 mass %. The spray rate of the sol in the spray drying is, for example, 15 g/min to 60 g/min, desirably 20 g/min to 50 g/min, and more desirably 22 g/min to 45 g/min.

Alternatively, the inorganic fine particles 22 (optionally two or more types of inorganic fine particles 22) and optionally a fluorescent dye, fluorescent brightener, dye, or pigment are added to a molten resin which is to be formed into the resin component 21, and these additives are uniformly mixed with the molten resin by kneading. The composite particles 20 can be obtained also by crushing the thus obtained resin block to a predetermined range of particle diameters. In terms of dispersing the inorganic fine particles 22 and other ingredients uniformly in the resin component or in terms of efficiently producing the composite particles 20 having the desired particle diameter and shape, it is desirable to fabricate the composite particles 20 by preparation of a sol followed by spray drying.

The composite particles 20 having a core-shell structure as shown in FIG. 2C can be produced, for example, by the procedures described hereinafter. A sol containing the inorganic fine particles 22 and the inorganic component 23 is prepared, and spray drying is performed using the prepared sol to form the core 24. This is followed by a treatment for coating the surface of the formed core 24 with the resin component 21. In this manner, the composite particles 20 having a core-shell structure can be produced. The surface coating treatment with the resin component 21 is accomplished, for example, by stirring a liquid mixture obtained by adding the core 24 to an emulsion in which the resin component 21 is dispersed. This allows the resin component 21 to collide with the core 24 and attach to the surface of the core 24 in the stirring chamber, with the result that the surface of the core 24 is coated with the resin component 21.

The composite particles 20 fabricated as above are dispersed uniformly in a fluid containing the matrix resin 10. An ink containing the matrix resin 10 and the composite particles 20 is thus prepared. The light diffusing and transmitting sheet 1 can be obtained by applying this ink onto a substrate such as a PET film and then solidifying the ink.

### EXAMPLES

The present invention will be described in detail by way of examples. It should be noted that the present invention is not limited to the examples given below.

<Fabrication of Composite Particles>

(Composite Particles A-1)

An aqueous dispersion of titanium dioxide fine particles (SJR-405SL, manufactured by Tayca Corporation and having an average particle diameter of 210 nm) and another type of titanium dioxide fine particles (WP0141, manufactured by Tayca Corporation and having an average particle diameter of 250 nm), a colloidal solution of silica fine particles (SNOWTEX N, manufactured by Nissan Chemical Industries, Ltd; average particle diameter of silica fine particles: 10 nm to 20 nm), and a polyurethane emulsion (TAKELAC WS-6021, manufactured by Mitsui Chemicals, Inc.) were mixed to prepare a sol. The total concentration of solids of titanium dioxide, silica, and polyurethane in the sol was adjusted with pure water to 14.6 mass %. The preparation of the sol was done so that, in total solids, the content of titanium dioxide, the content of silica, and the content of polyurethane were 50 mass %, 32 mass %, and 18 mass %, respectively. The polyurethane in the polyurethane emulsion contained a silanol group. The refractive index of this silanol group-containing polyurethane was 1.50 to 1.55.

The sol prepared was spray-dried using a spray dryer (MDL-050, manufactured by Fujisaki Electric Co., Ltd.) to fabricate composite particles A-1. The conditions of spraying of the sol were adjusted so that the average particle diameter of the composite particles A-1 fell within the range of 1 to 10 μm. The average particle diameter of the composite particles A-1 was measured using a laser diffraction-scattering particle size distribution analyzer (product name: Microtrac (MT-3000II), manufactured by NIKKISO CO., LTD.). The specimen used in the measurement was prepared by mixing an appropriate amount of the dried composite particles A-1 with pure water and dispersing the composite particles A-1 in the pure water under application of ultrasonic vibration (with 130 W for 1 minute). The respective average particle diameters of the various composite particles described hereinafter were measured in the same manner as that of the composite particles A-1.

(Inorganic Composite Particles B-1)

An aqueous dispersion of titanium dioxide fine particles (SJR-405SL, manufactured by Tayca Corporation and having an average particle diameter of 210 nm) and another type of titanium dioxide fine particles (WP0141, manufactured by Tayca Corporation and having an average particle diameter of 250 nm), tetramethoxysilane, and a colloidal solution of silica fine particles (SILICADOL 30, manufactured by Nippon Chemical Industrial Co., Ltd.; average particle diameter of silica fine particles: 10 nm to 20 nm) were mixed to prepare a sol. The preparation of the sol was done using pure water so that the total content of the solids such as the titanium dioxide fine particles, silica fine particles, and dispersant was 15 mass %. The content of the titanium dioxide fine particles in the inorganic solids in the sol was adjusted to 30 mass %.

The sol prepared was spray-dried using a spray dryer (MDL-050, manufactured by Fujisaki Electric Co., Ltd.) to fabricate inorganic composite particles B-1. The conditions of spraying of the sol were adjusted so that the average particle diameter of the inorganic composite particles fell within the range of 1 to 10 μm.

(Composite Particles A-2)

The inorganic composite particles B-1 were added to a polyurethane emulsion (TAKELAC WS-6021 manufactured by Mitsui Chemicals, Inc.), followed by the addition of pure water to prepare a liquid mixture having a solid content of 17 mass %. This liquid mixture was stirred under certain conditions to coat the surfaces of the inorganic composite particles B-1 with polyurethane. The polyurethane-coated inorganic composite particles B-1 were separated from the liquid mixture, then dried and crushed under certain conditions to obtain composite particles A-2. The conditions of the stirring, drying, and crushing were adjusted so that the average particle diameter of the composite particles A-2 fell within the range of 1 to 10 μm. The content of the polyurethane in the composite particles A-2 was 2 mass %.

(Composite Particles A-3)

The inorganic composite particles B-1 were added to an acrylic emulsion (MX-9017, manufactured by MITSUBISHI RAYON CO., LTD.), followed by the addition of pure water to prepare a liquid mixture having a solid content of 17 mass %. This liquid mixture was stirred under certain conditions to coat the surfaces of the inorganic composite particles B-1 with the acrylic resin. The acrylic resin-coated inorganic composite particles B-1 were separated from the liquid mixture, then dried and crushed under certain conditions to obtain composite particles A-3. The conditions of the stirring, drying, and crushing were adjusted so that the average particle diameter of the composite particles A-3 fell within the range of 1 to 10 μm. The content of the acrylic resin in the composite particles A-3 was 1 mass %.

(Composite Particles A-4)

The inorganic composite particles B-1 were added to an acrylic styrene emulsion (VONCOAT 5400EF, manufactured by DIC CORPORATION), followed by the addition of pure water to prepare a liquid mixture having a solid content of 17 mass %. This liquid mixture was stirred under certain conditions to coat the surfaces of the inorganic composite particles B-1 with the acrylic styrene resin. The acrylic styrene resin-coated inorganic composite particles B-1 were separated from the liquid mixture, then dried and crushed under certain conditions to obtain composite particles A-4. The conditions of the stirring, drying, and crushing were adjusted so that the average particle diameter of the composite particles A-4 fell within the range of 1 to 10 μm. The content of the acrylic resin in the composite particles A-4 was 3 mass %.

(Composite Particles A-5)

The inorganic composite particles B-1 were added to an emulsion of an acrylic-modified urethane resin (RIKA BOND SU-200, manufactured by CHUO RIKA KOGYO CORPORATION), followed by the addition of pure water to prepare a liquid mixture having a solid content of 17 mass %. This liquid mixture was stirred under certain conditions to coat the surfaces of the inorganic composite particles B-1 with the acrylic-modified urethane resin. The acrylic-modified urethane resin-coated inorganic composite particles B-1 were separated from the liquid mixture, then dried and crushed under certain conditions to obtain composite particles A-5. The conditions of the stirring, drying, and crushing were adjusted so that the average particle diameter of the composite particles A-5 fell within the range of 1 to 10 μm. The content of the acrylic resin in the composite particles A-5 was 3 mass %.

(Composite Particles A-6 to Composite Particles A-9)

Composite particles A-6 were fabricated in the same manner as the composite particles A-1, except that the titanium dioxide fine particles used included only titanium dioxide fine particles having an average particle diameter of 210 nm, that the polyurethane emulsion used was TAKELAC W-6020 manufactured by Mitsui Chemicals, Inc., and that the contents of the titanium dioxide fine particles, silica fine particles, and polyurethane in total solids in the sol were 30 mass %, 43 mass %, and 27 mass %, respectively. Composite particles A-7 were fabricated in the same manner as the composite particles A-6, except for using titanium dioxide fine particles having an average particle diameter of 250 nm. Composite particles A-8 were fabricated in the same manner as the composite particles A-6, except for using titanium dioxide fine particles having an average particle diameter of 300 nm. Composite particles A-9 were fabricated in the same manner as the composite particles A-6, except for using titanium dioxide fine particles having an average particle diameter of 400 nm.

(Composite Particles A-10 to A-15)

Composite particles A-10, composite particles A-11, composite particles A-12, composite particles A-13, composite particles A-14, and composite particles A-15 were fabricated in the same manner as the composite particles A-1, except that the titanium dioxide fine particles used included only SJB-405SL (manufactured by Tayca Corporation and having an average particle diameter of 210 nm), that the polyurethane emulsion used was TAKELAC W-6020 manufactured by Mitsui Chemicals, Inc., and that the contents of the titanium dioxide fine particles, silica fine particles, and polyurethane in total solids in the sol were adjusted as shown in Table 1.

TABLE 1

| | Content of titanium | Content of silica | Content of |
|---|---|---|---|
| Composite | oxide fine particles | fine particles | polyurethane |
| particles | [mass %] | [mass %] | [mass %] |
| A-10 | 10 | 63 | 27 |
| A-11 | 20 | 53 | 27 |
| A-12 | 30 | 43 | 27 |
| A-13 | 40 | 33 | 27 |
| A-14 | 52 | 21 | 27 |
| A-15 | 70 | 3 | 27 |

(Composite Particles A-16)

Composite particles A-16 were fabricated in the same manner as the composite particles A-1, except that the titanium dioxide fine particles used included only SJR-405SL (manufactured by Tayca Corporation and having an average particle diameter of 210 nm), that the polyurethane emulsion used was TAKELAC W-6020 manufactured by Mitsui Chemicals, Inc., that the contents of the titanium dioxide fine particles, silica fine particles, and polyurethane in total solids in the sol were adjusted to 10 mass %, 63 mass %, and 27 mass %, respectively, that the total solid concentration in the sol was adjusted to 15 mass %, and that the spray rate in the spray drying was adjusted in the range of 22.2 g/min to 22.4 g/min. The volumetric particle size distribution of the composite particles A-16 was measured, with the result that the proportion of particles having a particle diameter of 20 μm or more was found to be 1% or less. A scanning electron microscope (SEM) photograph of the composite particles A-16 is shown in FIG. 4.

(Composite Particles A-17)

Composite particles A-17 were fabricated in the same manner as the composite particles A-16, except that the spray rate in the spray drying was adjusted to 30 g/min. The volumetric particle size distribution of the composite particles A-17 was measured, with the result that the proportion of particles having a particle diameter of 20 μm or more was found to be about 30%. A SEM photograph of the composite particles A-17 is shown in FIG. 5.

(Composite Particles A-18)

Composite particles A-18 were fabricated in the same manner as the composite particles A-1, except that the titanium dioxide fine particles used included only SJR-405SL (manufactured by Tayca Corporation and having an average particle diameter of 210 nm), that the polyurethane emulsion used was TAKELAC W-6020 manufactured by Mitsui Chemicals, Inc., and that the contents of the titanium dioxide fine particles, silica fine particles, and polyurethane in total solids in the sol were 40 mass %, 33 mass %, and 27 mass %, respectively.

(Composite Particles A-19)

Composite particles A-19 were fabricated in the same manner as the composite particles A-18, except that barium sulfate fine particles (product name: B-30, manufactured by SAKAI CHEMICAL INDUSTRY CO., LTD. and having an average particle diameter of 300 nm) were further added to the sol and that the contents of the titanium dioxide fine particles, silica fine particles, polyurethane, and barium sulfate fine particles in total solids in the sol were 20 mass %, 33 mass %, 27 mass %, and 20 mass %, respectively. The refractive index of the barium sulfate was 1.64. The refractive index of the titanium dioxide was 2.70 and the refractive index of the polyurethane was 1.55.

(Composite Particles A-20)

Composite particles A-20 were fabricated in the same manner as the composite particles A-18, except that zinc oxide fine particles (product name: MZ-500HP, manufactured by Tayca Corporation and having an average particle diameter of 20 nm) were further added to the sol and that the contents of the titanium dioxide fine particles, silica fine particles, polyurethane, and zinc oxide fine particles in total solids in the sol were 20 mass %, 33 mass %, 27 mass %, and 20 mass %, respectively. The refractive index of the zinc oxide was 1.94.

(Composite Particles A-21 and Composite Particles A-22)

Composite particles A-21 were fabricated in the same manner as the composite particles A-1, except that no titanium dioxide fine particles were used, that the polyurethane emulsion used was TAKELAC W-6020 manufactured by Mitsui Chemicals, Inc., that zinc oxide fine particles (ZP142, manufactured by Tayca Corporation and having an average particle diameter of about 20 nm) and fluorescent dyes (Hokkaol BYL and Hokkaol RG manufactured by SHOWA KAGAKU KOGYO CO., LTD.) were further added to the sol, and that the contents of the silica fine particles, polyurethane, zinc oxide fine particles, Hokkaol BYL, and Hokkaol RG in total solids in the sol were 68 mass %, 23 mass %, 7 mass %, 1.5 mass %, and 0.5 mass %, respectively. Composite particles A-22 were fabricated in the same manner as the composite particles A-21, except that the contents of the silica fine particles, polyurethane, zinc oxide fine particles, Hokkaol BYL, and Hokkaol RG in total solids in the sol were 68.5 mass %, 23 mass %, 7 mass %, 1.0 mass %, and 0.5 mass %, respectively.

(Composite Particles A-23)

An aqueous dispersion of titanium dioxide fine particles (SJR-405SL, manufactured by Tayca Corporation and having an average particle diameter of 210 nm), a colloidal solution of silica fine particles (SNOWTEX N, manufactured by Nissan Chemical Industries, Ltd; average particle diameter of silica fine particles: 10 nm to 20 nm), and a polyurethane emulsion (TAKELAC WS-6020, manufactured by Mitsui Chemicals, Inc.) were mixed, and zinc oxide fine particles (product name: MZ-500HP, manufactured by Tayca Corporation and having an average particle diameter of 20 nm) and phthalocyanine blue (copper(II) phthalocyanine-tetrasulfonic acid tetrasodium salt, manufactured by Sigma-Aldrich Corporation) were further added to prepare a sol. The total concentration of solids of titanium dioxide, silica, polyurethane, zinc oxide, and phthalocyanine blue in the sol was adjusted to 15 mass % with pure water. The preparation of the sol was done so that in total solids, the content of titanium dioxide, the content of silica, the content of polyurethane, the content of zinc oxide, and the content of phthalocyanine blue were 23 mass %, 43 mass %, 27 mass %, 7 mass %, and 2 ppm, respectively.

The sol prepared was spray-dried using a spray dryer (MDL-050, manufactured by Fujisaki Electric Co., Ltd.) to fabricate composite particles A-23. The spray rate in the spray drying was adjusted in the range of 22.2 g/min to 22.4 g/min.

(Composite Particles A-24)

A sol was prepared by mixing a colloidal solution of silica fine particles and a polyurethane emulsion so that the contents of the silica fine particles and polyurethane in total solids in the sol were 68.1 mass % and 31.9 mass %, respectively. The silica fine particle colloidal solution used was a solution obtained by mixing SNOWTEX XS (manufactured by Nissan Chemical Industries, Ltd.; average particle diameter of silica fine particles: 4 nm to 6 nm) and SILICADOL 30S (manufactured by Nippon Chemical Industrial Co., Ltd.; average particle diameter of silica fine particles: 7 nm to 10 nm) so that the weight ratio based on solids (the weight of the silica fine particles contained in SNOWTEX XS:the weight of the silica fine particles contained in SILICADOL 30S) was 2:8. The polyurethane emulsion used was an emulsion obtained by mixing TAKELAC W-6020 (manufactured by Mitsui Chemicals, Inc.) and TAKELAC WS-6021 (manufactured by Mitsui Chemicals, Inc.) so that the weight ratio based on solids (the weight of solids contained in TAKELAC W-6020:the weight of solids contained in TAKELAC WS-6021) was 9:1. Next, the sol prepared was spray-dried using a spray dryer (MDL-050, manufactured by Fujisaki Electric Co., Ltd.) to fabricate composite particles A-24. The spray rate of the spray dryer was adjusted in the range of 22.2 g/min to 22.4 g/min.

(Composite Particles A-25 to A-29)

Composite particles A-25, composite particles A-26, composite particles A-27, composite particles A-28, and composite particles A-29 were fabricated in the same manner as the composite particles A-24, except for adding a fluorescent brightener to the sol so that the content of the fluorescent brightener in total solids in the sol was 0.0046 mass % for the composite particles A-25, 0.0093 mass % for the composite particles A-26, 0.0139 mass % for the composite particles A-27, 0.0185 mass % for the composite particles A-28, and 0.0231 mass % for the composite particles A-29. The fluorescent brightener used was a mixture obtained by mixing CBS-X (manufactured by BASF) and DMA-Xconc (manufactured by BASF) so that the weight ratio based on solids (the weight of solids contained in CBS-X:the weight of solids contained in DMA-Xconc) was 1:1.

(Composite Particles A-30 to A-35)

Composite particles A-30, composite particles A-31, composite particles A-32, composite particles A-33, composite particles A-34, and composite particles A-35 were fabricated in the same manner as the composite particles A-24, except for adjusting the added amounts of the colloidal solution of silica fine particles and the polyurethane emulsion so that the contents of the silica fine particles and polyurethane in total solids in the sol were as shown in Table 2 and for adding a fluorescent brightener to the sol so that the content of the fluorescent brightener in total solids in the sol was 0.0139 mass %. The fluorescent brightener used was a mixture obtained by mixing CBS-X (manufactured by BASF) and DMA-Xconc (manufactured by BASF) so that the weight ratio based on solids (the weight of solids contained in CBS-X:the weight of solids contained in DMA-Xconc) was 1:1.

TABLE 2

| | Content of silica fine particles | Content of polyurethane |
|---|---|---|
| | in total solids in sol | in total solids in sol |
| | [mass %] | [mass %] |
| Composite | 87.3 | 12.7 |
| particles A-30 | | |
| Composite | 81.0 | 19.0 |
| particles A-31 | | |
| Composite | 74.6 | 25.4 |
| particles A-32 | | |
| Composite | 68.1 | 31.9 |
| particles A-33 | | |
| Composite | 61.8 | 38.1 |
| particles A-34 | | |
| Composite | 55.5 | 44.5 |
| particles A-35 | | |

(Composite Particles A-36 to A-41)

Composite particles A-36, composite particles A-37, composite particles A-38, composite particles A-39, composite particles A-40, and composite particles A-41 were fabricated in the same manner as the composite particles A-24, except for adding a fluorescent brightener to the sol so that the content of the fluorescent brightener in total solids in the sol was 0.139 mass % and for adding phthalocyanine blue (515306, manufactured by Heubach) to the sol so that the content of the phthalocyanine blue in total solids in the sol was 0.0017 weight % for the composite particles A-36, 0.0025 weight % for the composite particles A-37, 0.0038 weight % for the composite particles A-38, 0.0050 weight % for the composite particles A-39, 0.0063 weight % for the composite particles A-40, and 0.0075 weight % for the composite particles A-41. The fluorescent brightener used was a mixture obtained by mixing CBS-X (manufactured by BASF) and DMA-Xconc (manufactured by BASF) so that the weight ratio based on solids (the weight of solids contained in CBS-X:the weight of solids contained in DMA-Xconc) was 1:1.

<Preparation of Samples for Evaluation of Damaging Properties>

The composite particles A-1 were dispersed in an acrylic resin (Autoclear, manufactured by NIPPON PAINT Co., Ltd.) to prepare an ink. This ink was applied to a 20-μm-thick PET film using a doctor blade technique and then solidified to prepare Sample C-1. In this case, the thickness of the coating film of Sample C-1 was 10 μm, and the content of the composite particles in the coating film of Sample C-1 was 50 mass %. Sample C-2 was prepared in the same manner as Sample C-1 except for using the composite particles A-2. Sample C-3 was prepared in the same manner as Sample C-1 except for using the composite particles A-3. Sample C-4 was prepared in the same manner as Sample C-1 except for using the composite particles A-4. Sample C-5 was prepared in the same manner as Sample C-1 except for using the composite particles A-5. Sample D-1 was prepared in the same manner as Sample C-1 except for using the inorganic composite particles B-1. These samples were evaluated for damaging properties in the manner described below.

<Evaluation of Damaging Properties>

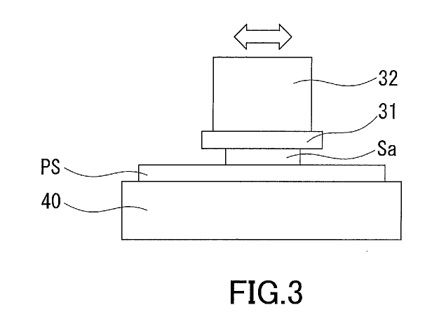

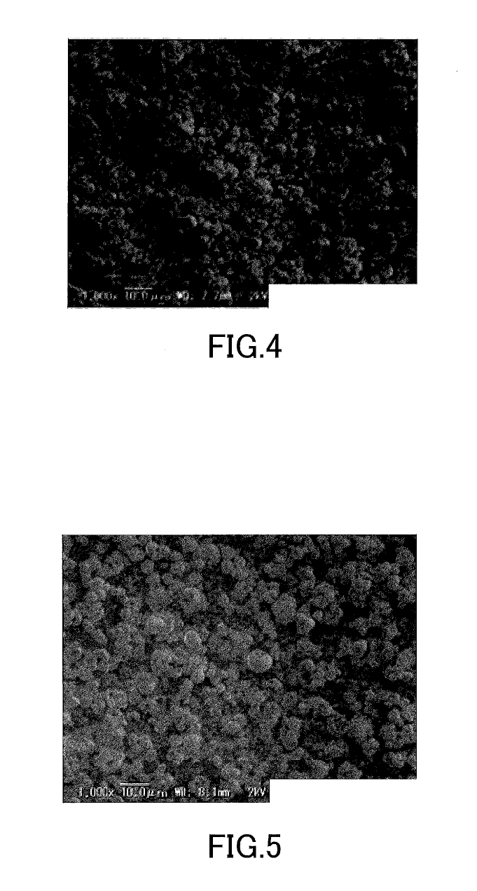

Using the device shown in FIG. 3, evaluation was made on how much the samples of light diffusing and transmitting sheet damage another member by contact. A 50-mm-long, 26-mm-wide, brightness enhancement film PS (BEF4-GT-90(24), manufactured by 3M) was attached to a support 40 using a double-faced adhesive tape. Next, a 10-mm-long, 10-mm-wide sample Sa of light diffusing and transmitting sheet was attached to a flat friction block 31 using a double-faced tape. Then, the sample Sa was placed in contact with the brightness enhancement film PS as shown in FIG. 3. A weight 32 was put on the top of the flat friction block 31 so that a load of 58.8 N was applied to the brightness enhancement film PS. In this state, the flat friction block 31 was reciprocated above the brightness enhancement film PS over a distance of 10 mm at an average speed of 8.7 m/min to rub the brightness enhancement film PS with the sample Sa. The degree of damage to the brightness enhancement film PS rubbed with the sample Sa was evaluated by visual inspection on an 11-point rating scale. A rating of “0” was given when the brightness enhancement film PS was free of any damage, and a rating of “10” was given to the degree of damage to the brightness enhancement film PS caused when a sample Sa containing no resin component (Sample D-1) was used. The results are shown in Table 3.

TABLE 3

| | | Rating of damaging |
|---|---|---|
| Sample | Surface coating | properties |
| C-1 | — | 0 |
| C-2 | Silanol group-containing | 5 |
| | polyurethane | |
| C-3 | Acrylic resin | 7 |
| C-4 | Acrylic styrene resin | 7 |
| C-5 | Acrylic-modified urethane resin | 7 |
| D-1 | No surface coating | 10 |

As shown in Table 3, Sample C-1, Sample C-2, Sample C-3, Sample C-4, and Sample C-5 caused less damage to the brightness enhancement film PS than Sample D-1. This suggested that when composite particles each including inorganic fine particles enclosed in a resin component are dispersed in a matrix resin to form a light diffusing and transmitting sheet, the possibility of damaging another member in contact with the light diffusing and transmitting sheet can be reduced. In particular, Sample C-1 or Sample C-2, in which composite particles formed using a silanol group-containing polyurethane resin were used, caused much less damage to the brightness enhancement film PS. Furthermore, the sample (C-1) in which composite particles including a resin component and an inorganic component blended together were used caused less damage to the brightness enhancement film PS than the samples (Sample C-2, Sample C-3, Sample C-4, and Sample C-5) in which composite particles having a structure having a shell formed of a resin component were used.

Next, methods for evaluating the optical properties of samples of light diffusing and transmitting sheet prepared using the above composite particles or inorganic composite particles will be described.

<Luminance and Chromatic Properties>

For the measurement of luminance and chromaticity, either of the methods a and b described below was selectively used depending on the samples. For the measurement in which the method b was used, the fact of using the method b will be specified. Unless specified, it should be understood that the method used for measurement was the method a.

(Method a)

A backlight of a smartphone (iphone 5, manufactured by Apple Inc.) was used as a light source, and light from this light source was incident on the sample of light diffusing and transmitting sheet from below. The luminance at a point 50 cm above a source of the transmitted light (the sample of light diffusing and transmitting sheet) was measured with a luminance meter (BM-7, manufactured by TOPCON TECHNOHOUSE CORPORATION). The measurement angle of the luminance meter was set to 0.1 degrees. The chromaticity in the xyY color system was also measured using this luminance meter.

(Method b)

The luminance and chromaticity derived from making light incident on the sample from a light source were measured in the same manner as in the method a, except that a two-dimensional luminance meter (product name: RISA-COLOE, manufactured by HI-LAND) was used instead of the above luminance meter.

<Haze Ratio>

The total light transmittance and haze ratio of the samples of light diffusing and transmitting sheet for incident light with a wavelength of 555 nm were measured using a spectrophotometer (UV-3600, manufactured by Shimadzu Corporation) and an integrating sphere.

<Transmitted Light Scattering Properties>

Transmitted light scattering profiles of the samples of light diffusing and transmitting sheet were measured using GENESIA Gonio/Far Field Profiler (manufactured by Genesia Corporation). The incident angle of a light beam was set to 0 degree. That is, a light beam was perpendicularly incident on each sample of light diffusing and transmitting sheet.

<Viewing Angle Properties>

In the measurement of transmitted light scattering profiles of the samples of light diffusing and transmitting sheet by means of GENESIA Gonio/Far Field Profiler (manufactured by Genesia Corporation), the amount of light was measured versus the scattering angle θ (corresponding to the latitude) at φ=0 degree (corresponding to a longitude of 0 degree), and a half-value angle determined through normalization with respect to the intensity of straight transmitted light (θ=0 degree) was defined as a half width at half maximum. The viewing angle properties of each light diffusing and transmitting sheet were evaluated on the basis of the half width at half maximum.

<Preparation of Samples for Evaluation of Optical Properties>

(Samples E-1 to E-3)

The composite particles A-1 were dispersed in an acrylic resin (Autoclear, manufactured by NIPPON PAINT Co., Ltd.) to prepare an ink. This ink was applied to a 1-mm-thick glass substrate using a doctor blade technique and then solidified to prepare Sample E-1. In this case, the thickness of the coating film of Sample E-1 was 15 μm, and the content of the composite particles A-1 in the coating film of Sample E-1 was 33 mass %. Sample E-2 was prepared in the same manner as Sample E-1, except for preparing the ink so that the content of the composite particles in the coating film was 15 mass % and for adjusting the thickness of the coating film to 18 μm. Sample E-3 was prepared in the same manner as Sample E-1, except for preparing the ink so that the content of the composite particles in the coating film was 7 mass % and for adjusting the thickness of the coating film to 18 μm.

(Samples F-1 to F-3)

The inorganic composite particles B-1 were dispersed in an acrylic resin (Autoclear, manufactured by NIPPON PAINT Co., Ltd.) to prepare an ink. This ink was applied to a 1-mm-thick glass substrate using a doctor blade technique and then solidified to prepare Sample F-1. In this case, the thickness of the coating film of Sample F-1 was 19 μm, and the content of the inorganic composite particles B-1 in the coating film of Sample F-1 was 33 mass %. Sample F-2 was prepared in the same manner as Sample F-1, except for preparing the ink so that the content of the inorganic composite particles in the coating film was 15 mass % and for adjusting the thickness of the coating film to 18 μm. Sample F-3 was prepared in the same manner as Sample F-1, except for preparing the ink so that the content of the composite particles in the coating film was 7 mass % and for adjusting the thickness of the coating film to 17 μm.

(Samples G-1 to G-4)

The composite particles A-6 were dispersed in an acrylic resin (Autoclear, manufactured by NIPPON PAINT Co., Ltd.) to prepare an ink. This ink was applied to a 20-μm-thick PET film using a doctor blade technique and then solidified to prepare Sample G-1. The content of the composite particles A-6 in the coating film of Sample G-1 was 47.5 mass %. The thickness of the coating film was 15 μm. Sample G-2, Sample G-3, and Sample G-4 were prepared using the composite particles A-7, composite particles A-8, and composite particles A-9, respectively, in the same manner as Sample G-1.

(Samples H-1 to H-6)

The composite particles A-10 were dispersed in an acrylic resin (Autoclear, manufactured by NIPPON PAINT Co., Ltd.) to prepare an ink. This ink was applied to a 20-μm-thick PET film using a doctor blade technique and then solidified to prepare Sample H-1. The content of the composite particles A-10 in the coating film of Sample H-1 was 47.5 mass %. The thickness of the coating film was 15 μm. Sample H-2, Sample H-3, Sample H-4, Sample H-5, and Sample H-6 were prepared using the composite particles A-11, composite particles A-12, composite particles A-13, composite particles A-14, and composite particles A-15, respectively, in the same manner as Sample H-1.

(Sample I-1 and Sample I-2)

The composite particles A-16 were dispersed in an acrylic resin (Autoclear, manufactured by NIPPON PAINT Co., Ltd.) to prepare an ink. This ink was applied to a 20-μm-thick PET film using a doctor blade technique and then solidified to prepare Sample I-1. The content of the composite particles A-16 in the coating film of Sample I-1 was 47.5 mass %. The thickness of the coating film was 15 μm. Sample I-2 was prepared using the composite particles A-17 in the same manner as Sample I-1.

(Samples J-1 to Sample J-3)

The composite particles A-18 were dispersed in an acrylic resin (Autoclear, manufactured by NIPPON PAINT Co., Ltd.) to prepare an ink. This ink was applied to a 20-μm-thick PET film using a doctor blade technique and then solidified to prepare Sample J-1. The content of the composite particles A-18 in the coating film of Sample J-1 was 50 mass %. The thickness of the coating film was 15 μm. Sample J-2 and Sample J-3 were prepared using the composite particles A-19 and A-20, respectively, in the same manner as Sample J-1.

(Sample K-1 and Sample K-2)

The composite particles A-21 were dispersed in an acrylic resin (Autoclear, manufactured by NIPPON PAINT Co., Ltd.) to prepare an ink. This ink was applied to a 20-μm-thick PET film using a doctor blade technique and then solidified to prepare Sample K-1. The content of the composite particles A-21 in the coating film of Sample K-1 was 63 mass %. The thickness of the coating film was 8 μm. Sample K-2 was prepared in the same manner as Sample K-1, except for using the composite particles A-22 instead of the composite particles A-21. The content of the composite particles A-22 in the coating film of Sample K-2 was 63 mass %. The thickness of the coating film was 8 μm.

(Sample L-1)

The composite particles A-23 were dispersed in an acrylic resin (Autoclear, manufactured by NIPPON PAINT Co., Ltd.) to prepare an ink. This ink was applied to a 20-μm-thick PET film using a doctor blade technique and then solidified to prepare Sample L-1. The content of the composite particles A-23 in the coating film of Sample L-1 was 47.5 mass %. The thickness of the coating film was 15 μm.

(Samples M-1 to M-6)

The composite particles A-24, composite particles A-25, composite particles A-26, composite particles A-27, composite particles A-28, and composite particles A-29 were respectively dispersed in acrylic resins (Autoclear, manufactured by NIPPON PAINT Co., Ltd.) to prepare inks, which were respectively applied to 20-μm-thick PET films using a doctor blade technique and then solidified to prepare Sample M-1, Sample M-2, Sample M-3, Sample M-4, Sample M-5, and Sample M-6. The content of the composite particles A-24, composite particles A-25, composite particles A-26, composite particles A-27, composite particles A-28, or composite particles A-29 in the coating film of each of Samples M-1 to M-6 was 65 mass %. The thickness of the coating film of each of Samples M-1 to M-6 was 8 μm.

(Samples M-7 to M-12)

The composite particles A-30, composite particles A-31, composite particles A-32, composite particles A-33, composite particles A-34, and composite particles A-35 were respectively dispersed in acrylic resins (Autoclear, manufactured by NIPPON PAINT Co., Ltd.) to prepare inks, which were respectively applied to 20-μm-thick PET films using a doctor blade technique and then solidified to prepare Sample M-7, Sample M-8, Sample M-9, Sample M-10, Sample M-11, and Sample M-12. The content of the composite particles A-30, composite particles A-31, composite particles A-32, composite particles A-33, composite particles A-34, or composite particles A-35 in the coating film of each of Samples M-7 to M-12 was 65 mass %. The thickness of the coating film of each of Samples M-7 to M-12 was 8 μm.

(Samples N-1 to N-6)

The composite particles A-36, composite particles A-37, composite particles A-38, composite particles A-39, composite particles A-40, and composite particles A-41 were respectively dispersed in acrylic resins (Autoclear, manufactured by NIPPON PAINT Co., Ltd.) to prepare inks, which were respectively applied to 20-μm-thick PET films using a doctor blade technique and then solidified to prepare Sample N-1, Sample N-2, Sample N-3, Sample N-4, Sample N-5, and Sample N-6. The content of the composite particles A-36, composite particles A-37, composite particles A-38, composite particles A-39, composite particles A-40, or composite particles A-41 in each of Samples N-1 to N-6 was 65 mass %. The thickness of the coating film of each of Samples N-1 to N-6 was 8 μm.

<Results of Evaluation of Optical Properties>

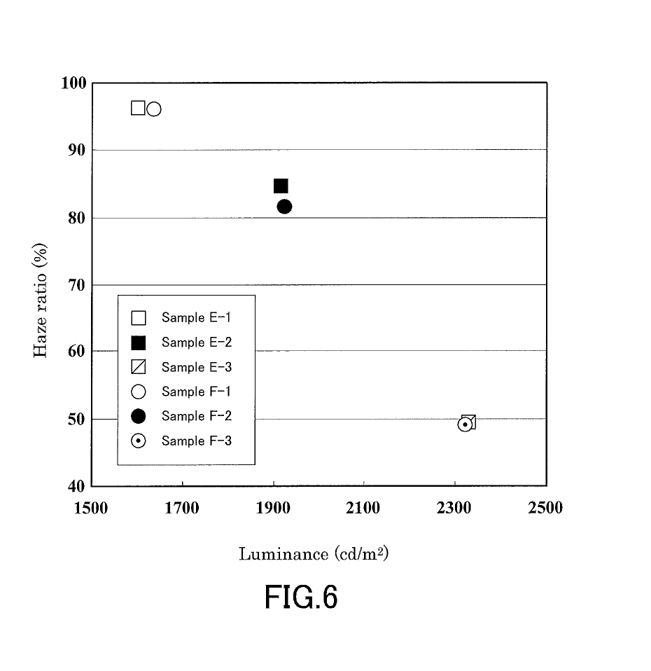

FIG. 6 shows the relationship between the luminance and haze ratio as measured using Sample E-1, Sample E-2, Sample E-3, Sample F-1, Sample F-2, and Sample F-3. As shown in FIG. 6, Sample E-1 and Sample F-1 showed similar levels of luminance and haze ratio. Sample E-2 and Sample F-2 showed similar levels of luminance and haze ratio. Sample E-3 and Sample F-3 showed similar levels of luminance and haze ratio. This suggested that when a light diffusing and transmitting sheet is formed to contain dispersed composite particles each including inorganic fine particles enclosed in a resin component, the sheet can attain optical properties (luminance properties and haze ratio) comparable to those of a light diffusing and transmitting sheet in which composite particles consisting essentially of only inorganic fine particles are dispersed.

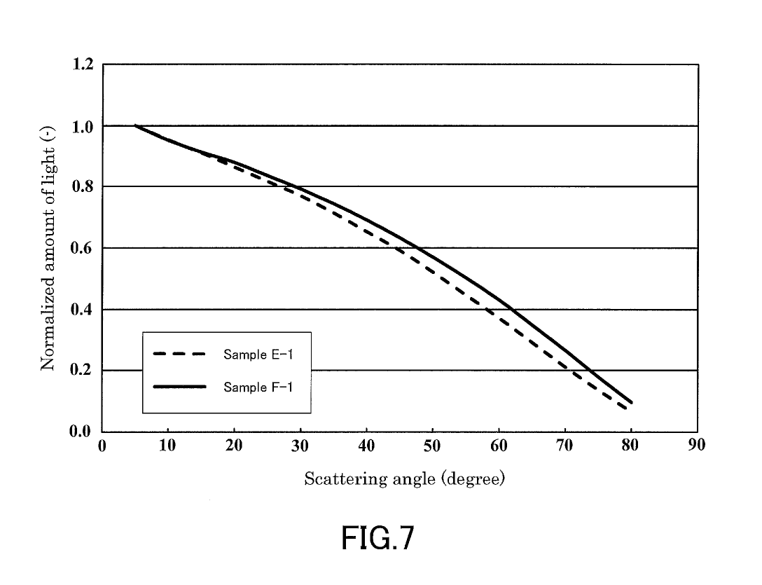

Transmitted light scattering profiles were measured using Sample E-1 and Sample F-1. The measurement results are shown in FIG. 7. As shown in FIG. 7, Sample E-1 showed scattering properties comparable to the scattering properties of Sample F-1. This suggested that when a light diffusing and transmitting sheet is formed to contain dispersed composite particles each including inorganic fine particles enclosed in a resin component, the sheet can attain light diffusing properties comparable to those of a light diffusing and transmitting sheet in which composite particles consisting essentially of only inorganic fine particles are dispersed.

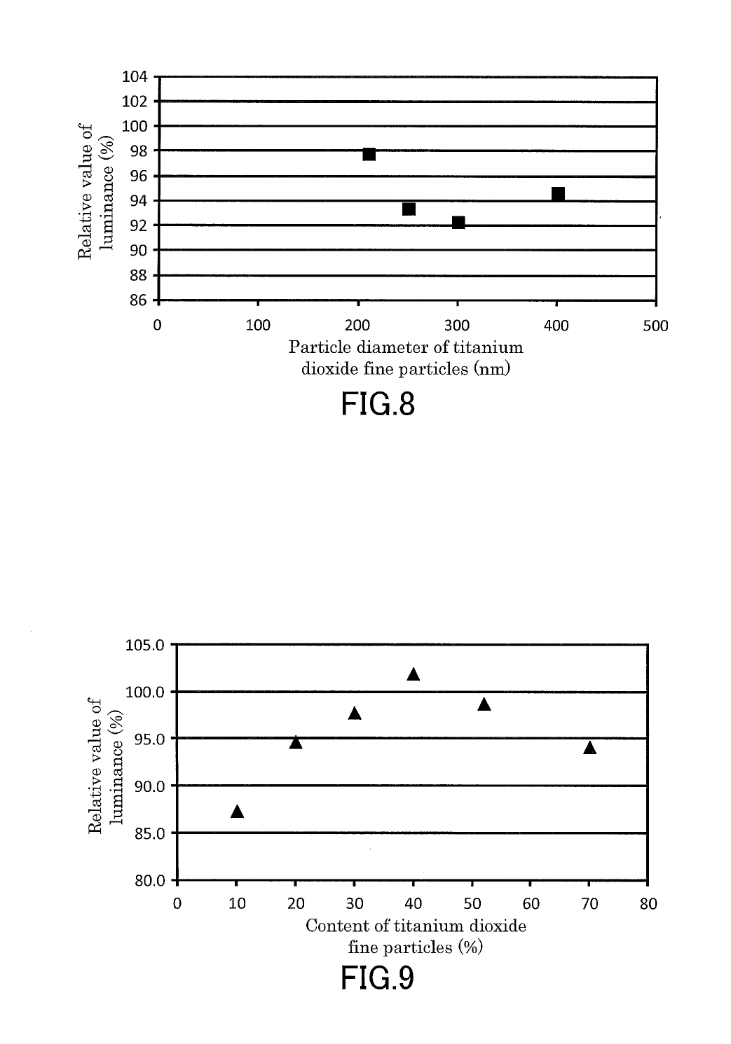

The luminance was measured for each of Sample G-1, Sample G-2, Sample G-3, and Sample G-4. FIG. 8 shows the relationship between the relative values of luminance measured for these samples and the average particle diameter of the titanium dioxide fine particles used in the samples. A relative value of luminance of 100% corresponds to a luminance of 9700 cd/cm². As shown in FIG. 8, the luminance was low when the average particle diameter of the titanium dioxide fine particles was 300 nm, while when the average particle diameter of the titanium dioxide fine particles was in the range below 300 nm, a relatively high luminance was observed. It is thought that, when the average particle diameter of the titanium dioxide fine particles is in the range below 300 nm, the smaller the average particle diameter of the titanium dioxide fine particles is, the more the reflection loss of light is reduced and the more the luminance is increased. A possible reason why a relatively low luminance was observed when the average particle diameter of the titanium dioxide fine particles was 300 nm is that reflection or scattering of light is enhanced when the average particle diameter of the titanium dioxide fine particles is about ½ of a wavelength of around 555 nm at which light has the maximum relative luminosity.

The luminance was measured for each of Sample H-1, Sample H-2, Sample H-3, Sample H-4, Sample H-5, and Sample H-6. FIG. 9 shows the relationship between the relative values of luminance measured for these samples and the content of the titanium dioxide fine particles used in the samples. A relative value of luminance of 100% corresponds to a luminance of 9700 cd/cm².

The luminance was measured for Sample I-1 and Sample I-2. The relative value of luminance measured for Sample I-1 was 103%, while the relative value of luminance measured for Sample I-2 was 87%. This suggested that the luminance properties of the light diffusing and transmitting sheet are improved when the particle diameter of the composite particles is 20 μm or less. A relative value of luminance of 100% corresponds to a luminance of 9500 cd/cm².

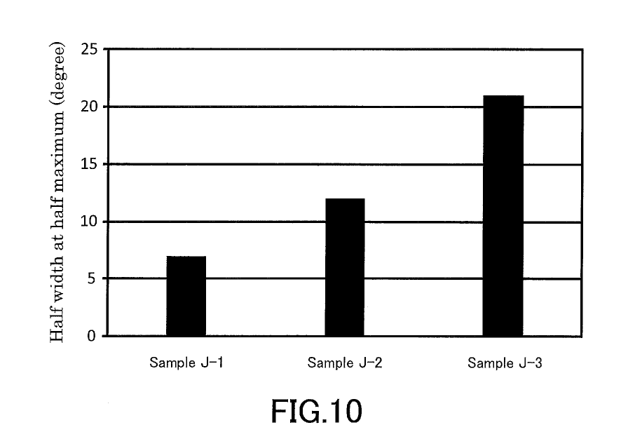

The viewing angle properties (half widths at half maximum) were measured using Sample J-1, Sample J-2, and Sample J-3. The results are shown in FIG. 10. Sample J-2 and Sample J-3 showed viewing angle properties better than the viewing angle properties of Sample J-1. In particular, Sample J-3 showed viewing angle properties about three times better than the viewing angle properties of the Sample J-1. It is thought that the addition of inorganic fine particles such as zinc oxide or barium sulfate fine particles provided more variations of interfaces between the materials and thus led to diversification of the way of light reflection, improving the light diffusing properties. It was suggested that the addition of inorganic fine particles such as zinc oxide or barium sulfate fine particles improves the light diffusing properties of the resulting light diffusing and transmitting sheet.

The luminance was measured for Sample K-1, and the relative value of luminance was 102.3%. A relative value of luminance of 100% corresponds to a luminance of 6100 cd/cm². Sample K-1 showed better luminance properties than the samples containing no fluorescent dye. This suggested that the luminance properties of the resulting light diffusing and transmitting sheet is improved by having the composite particles contain a fluorescent dye. The chromaticity was measured for Sample K-2, and the y value was 0.2930. The y value measured for the samples containing no fluorescent dye was 0.2968. The fluorescent dyes used were bluish dyes. It was suggested that the chromaticity of the resulting light diffusing and transmitting sheet can be adjusted by having the composite particles contain a fluorescent dye.

The luminance was measured for Sample L-1, and the relative value of luminance was 100.2%. A relative value of luminance of 100% corresponds to a luminance of 9500 cd/cm². It was suggested that adjusting the average particle diameter of the titanium dioxide fine particles, the content of the titanium dioxide fine particles, the content of the silica fine particles, and the conditions of the spray drying leads to a reduction in reflection loss of light and therefore an improvement in luminance properties of the resulting light diffusing and transmitting sheet.

The luminance was measured by the method b for each of Samples M-1 to M-6. The results are shown in Table 4. For all the samples, the relative value of luminance was 100% or more. A relative value of luminance of 100% corresponds to a luminance of 9500 cd/cm². The values of luminance measured for Samples M-2 to M-6 to which a fluorescent brightener was added were higher than the values of luminance measured for Sample M-1 to which no fluorescent brightener was added. For the luminance measured for Samples M-2 to M-6 to which a fluorescent brightener was added, no clear correlation with the amount of the fluorescent brightener added was observed.

TABLE 4

| | Sample No. | | | | | |
|---|---|---|---|---|---|---|
| | M-1 | M-2 | M-3 | M-4 | M-5 | M-6 |
| Relative value of | 100.0 | 100.4 | 100.5 | 100.4 | 100.5 | 100.3 |
| luminance [%] | | | | | | |

The luminance was measured by the method b for each of Samples M-7 to M-12. The results are shown in Table 5. For all the samples, the relative value of luminance was 100% or more. A relative value of luminance of 100% corresponds to a luminance of 9500 cd/cm². Among the values of luminance measured for these samples, the value of luminance measured for Sample M-11 was the highest.

TABLE 5

| | Sample No. | | | | | |
|---|---|---|---|---|---|---|
| | M-7 | M-8 | M-9 | M-10 | M-11 | M-12 |
| Relative value of | 100.2 | 100.2 | 100.7 | 101.0 | 101.5 | 101.0 |
| luminance [%] | | | | | | |

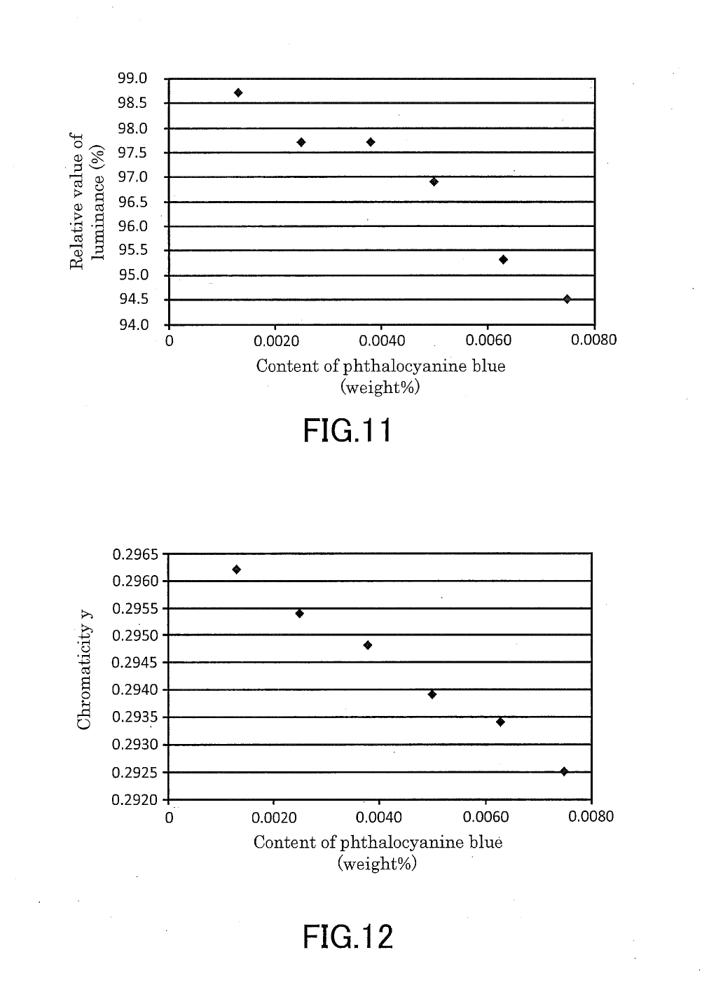

The luminance and the chromaticity y were measured by the method b for each of Samples N-1 to N-6. The results are shown in Table 6, FIG. 11, and FIG. 12. A relative value of luminance of 100% corresponds to a luminance of 9500 cd/cm². It was demonstrated that the addition of particles of a pigment such as phthalocyanine blue enables adjustment of the luminance and chromaticity.

TABLE 6

| | Sample No. | | | | | |
|---|---|---|---|---|---|---|
| | N-1 | N-2 | N-3 | N-4 | N-5 | N-6 |
| Relative value | 98.7 | 97.7 | 97.7 | 96.9 | 95.3 | 94.5 |
| of luminance | | | | | | |
| [%] | | | | | | |
| y value of | 0.2962 | 0.2954 | 0.2948 | 0.2939 | 0.2934 | 0.2925 |
| chromaticity | | | | | | |

1. A light diffusing and transmitting sheet comprising:
a matrix resin; and
composite particles dispersed in the matrix resin, the composite particles each comprising a resin component and inorganic fine particles enclosed in the resin component.

2. The light diffusing and transmitting sheet according to claim 1, wherein the composite particles have an average particle diameter of 1 μm to 20 μm.

3. The light diffusing and transmitting sheet according to claim 1, wherein the inorganic fine particles are fine particles of at least one selected from the group consisting of silica, titanium dioxide, zinc oxide, zirconium oxide, calcium carbonate, barium sulfate, zinc sulfide, aluminum hydroxide, and an extender pigment.

4. The light diffusing and transmitting sheet according to claim 1, wherein the inorganic fine particles are silica fine particles or titanium dioxide fine particles.

5. The light diffusing and transmitting sheet according to claim 1, wherein the composite particle comprises silica fine particles and titanium dioxide fine particles as the inorganic fine particles.

6. The light diffusing and transmitting sheet according to claim 5, wherein the composite particle further comprises fine particles of zinc oxide, barium sulfate, or calcium carbonate as the inorganic fine particles.

7. The light diffusing and transmitting sheet according to claim 4, wherein the silica fine particles have an average particle diameter of 1 nm to 100 nm.

8. The light diffusing and transmitting sheet according to claim 4, wherein the titanium dioxide fine particles have an average particle diameter of 100 nm to 500 nm.

9. The light diffusing and transmitting sheet according to claim 6, wherein the fine particles of zinc oxide, barium sulfate, or calcium carbonate have an average particle diameter of 10 nm to 500 nm.

10. The light diffusing and transmitting sheet according to claim 1, wherein a content of the inorganic fine particles is 50 mass % to 99 mass % and a content of the resin component is 1 mass % to 50 mass %.

11. The light diffusing and transmitting sheet according to claim 1, wherein the resin component comprises at least one resin selected from the group consisting of an acrylic resin, a polyurethane resin, and a nylon.

12. The light diffusing and transmitting sheet according to claim 1, wherein the composite particle further comprises a fluorescent dye or a fluorescent brightener.

13. The light diffusing and transmitting sheet according to claim 1, wherein the composite particle further comprises a dye or a pigment.

14. The light diffusing and transmitting sheet according to claim 1, wherein a difference between a refractive index of the resin component and a refractive index of the inorganic fine particles is 0.05 or more.

15. The light diffusing and transmitting sheet according to claim 1, wherein
the composite particle comprises, as the inorganic fine particles, first inorganic fine particles having a relatively high refractive index and second inorganic fine particles having a relatively low refractive index, and
a difference between a refractive index of the resin component and the refractive index of the second inorganic fine particles is 0.05 or more.

16. The light diffusing and transmitting sheet according to claim 2, wherein the inorganic fine particles are fine particles of at least one selected from the group consisting of silica, titanium dioxide, zinc oxide, zirconium oxide, calcium carbonate, barium sulfate, zinc sulfide, aluminum hydroxide, and an extender pigment.

17. The light diffusing and transmitting sheet according to claim 5, wherein the silica fine particles have an average particle diameter of 1 nm to 100 nm.

18. The light diffusing and transmitting sheet according to claim 5, wherein the titanium dioxide fine particles have an average particle diameter of 100 nm to 500 nm.
